(19) United States
(12) Patent Application Publication
(10) Pub. No.: US 2026/0016869 A1
(43) Pub. Date: Jan. 15, 2026

(54) INFORMATION DEVICE AND WIRING STRUCTURE

(71) Applicant: SUMITOMO ELECTRIC INDUSTRIES, LTD., Osaka-shi (JP)

(72) Inventors: Masaki SUZUKI, Osaka (JP); Takeshi Inoue, Osaka (JP); Yasunori Asano, Osaka (JP); Shun Endo, Osaka (JP)

(73) Assignee: SUMITOMO ELECTRIC INDUSTRIES, LTD., Osaka-shi (JP)

(21) Appl. No.: 19/240,882

(22) Filed: Jun. 17, 2025

(30) Foreign Application Priority Data
Jul. 12, 2024 (JP) 2024-112301

(51) Int. Cl. G06F 1/16

(52) U.S. Cl. CPC G06F 1/1683; G06F 1/1616; G06F 1/1686

(57) ABSTRACT

An information device according to an embodiment is an information device including a first part and a second part connected to each other via a hinge portion. The information device includes a first terminal disposed at a first part, a second terminal disposed at a second part, and an optical fiber configured to optically connect the first terminal and the second terminal to each other. The optical fiber extends from the first terminal to the second terminal through the hinge portion.

### CROSS REFERENCE TO RELATED APPLICATIONS

This application claims priority based on Japanese Patent Application No. 2024-112301 filed on Jul. 12, 2024, and the entire contents of the Japanese patent application are incorporated herein by reference.

### TECHNICAL FIELD

The present disclosure relates to an information device and a wiring structure.

### BACKGROUND

Patent literature 1 (Japanese Unexamined Patent Application Publication No. 2001-154760) describes a display connection structure. The display connection structure includes a main body, a display receiving an image signal from the main body, a mounting means for mounting the display to the main body, and an optical connector for transmitting the image signal by light. The optical connector includes a light emitting module rotatably provided on the main body and a light receiving module provided on the display.

The light emitting module includes a laser diode. A driving portion is connected to the laser diode via a cable. The driving portion receives power from the auxiliary power supply and drives the laser diode. The light receiving module has a photodiode array. The laser diode and the photodiode array are oriented with a predetermined distance therebetween so as to be optically communicated with each other.

Patent literature 2 (Japanese Unexamined Patent Application Publication No. 2011-119698) describes a laptop with a hinge mechanism. The laptop includes a first housing having a circuit substrate, a hard disk drive, and the like built therein, and a second housing having a liquid crystal display. The first housing and the second housing are supported rotatably with respect to each other via the hinge portion. The hinge portion includes a shaft. The shaft has a column portion, and the central axis of the column portion is eccentric with respect to the rotation central axis of the shaft.

A first connector is built in the first housing, and a second connector is built in the second housing. The first connector and the second connector are electrically connected to each other via a cable. The laptop can be shifted to a first state in which the laptop is opened by 90 degrees and a second state in which the laptop is closed. When the laptop is in the first state, the cable is not largely bent. When the laptop is closed and the state is changed from the first state to the second state, the part of the cable located near the shaft is curved, and the cable approaches the column portion of the shaft. Since the column portion of the shaft is eccentric from the rotation center axis, the column portion is moved away from the cable in the second state.

Patent literature 3 (Japanese Unexamined Patent Application Publication No. 6-131077) describes a tape recorder editing machine having an electronic apparatus body and a rotary apparatus which is a display unit rotatable with respect to the electronic apparatus body. The electronic apparatus body has a pair of left and right recesses on both left and right sides of an upper portion thereof. The rotary apparatus has a pair of left and right protrusions on both left and right sides of a lower portion thereof.

The tape recorder editing machine has a hinge mechanism provided between a recess of the electronic apparatus body and a projection of the rotary apparatus, and an electric wire for electrically connecting the electronic apparatus body and the rotary apparatus to each other. The hinge mechanism has a cylindrical body. The electric wire is bent in a direction perpendicular to the axis of the cylindrical body inside the cylindrical body.

### SUMMARY

An information device according to the present disclosure is an information device including a first part and a second part connected to each other via a hinge portion. The information device includes a first terminal disposed at a first part, a second terminal disposed at a second part, and an optical fiber configured to optically connect the first terminal and the second terminal to each other. The optical fiber extends from the first terminal to the second terminal through the hinge portion.

### BRIEF DESCRIPTION OF THE DRAWINGS

FIG. 1 is a perspective view illustrating an example of an information device according to an embodiment.

FIG. 2 is a diagram illustrating a wiring structure according to an embodiment.

FIG. 3 is a diagram illustrating a wiring structure according to a first modification.

FIG. 4 is a diagram illustrating a wiring structure according to a second modification.

FIG. 5 is a diagram illustrating a wiring structure according to a third modification, a fourth modification, a fifth modification, and a sixth modification.

FIG. 6 is a diagram illustrating a wiring structure according to a seventh modification.

FIG. 7 is a diagram illustrating a wiring structure according to an eighth modification, a ninth modification, a tenth modification, and an eleventh modification.

FIG. 8 is a diagram illustrating an information device with a wiring structure according to a twelfth modification.

FIG. 9 is a diagram illustrating a wiring structure according to a thirteenth modification.

FIG. 10 is a diagram illustrating an information device with a wiring structure according to a fourteenth modification.

FIG. 11 is a diagram illustrating a wiring structure according to a fifteenth modification and a sixteenth modification.

FIG. 12 is a diagram illustrating a wiring structure for a seventeenth modification, an eighteenth modification, and a nineteenth modification.

FIG. 13 is a diagram illustrating a wiring structure according to a twentieth modification.

FIG. 14 is a diagram illustrating a wiring structure according to a twenty-first modification and a twenty-second modification.

### DETAILED DESCRIPTION

In an information device, the transmission capacitance of signals is increasing for the reason that the performance of electric equipment built in the information device is improved. It is assumed that the number of electrical devices mounted on the information device increases. With an increase in the transmission capacitance of signals and an increase in the number of electric devices mounted on the information device, there is a possibility that the electric wire needs to be thickened or the number of electric wires needs to be increased. In this case, the area occupied by the wiring in the information device increases, and thus there is a concern that the information device may increase in size. Thus, it is required to reduce the area occupied by the wiring and to miniaturize the information device.

An object of the present disclosure is to provide an information device and a wiring structure which can be miniaturized by reducing an area occupied by wiring.

### DESCRIPTION OF EMBODIMENTS OF PRESENT DISCLOSURE

First, the contents of embodiments of the present disclosure will be listed and explained. (1) An information device according to an embodiment is an information device including a first part and a second part connected to each other via a hinge portion. The information device includes a first terminal disposed at a first part, a second terminal disposed at a second part, and an optical fiber configured to optically connect the first terminal and the second terminal to each other. The optical fiber extends from the first terminal to the second terminal through the hinge portion.

(11) A wiring structure according to an embodiment is a wiring structure configured to be provided in an information device including a first part and a second part connected to each other via a hinge portion. The wiring structure includes a first terminal disposed at the first part, a second terminal disposed at the second part, and an optical fiber configured to optically connect the first terminal and the second terminal to each other. The optical fiber is disposed to extend from the first terminal to the second terminal through the hinge portion.

The information device and the wiring structure include a first terminal, a second terminal, and an optical fiber. The first terminal is disposed in the first part of the information device, and the second terminal is disposed in the second part of the information device. The optical fiber is passed through the hinge portion of the information device and is configured to optically connect the first terminal and the second terminal to each other. The first terminal disposed in the first part is connected to the second terminal disposed in the second part through the optical fiber, and thus a large amount of signal transmission can be performed by the optical fiber which is thin and has a small number of fibers. Thus, since the area occupied by the optical fiber in the information device can be reduced, the area occupied by the wiring can be reduced, and the information device can be miniaturized.
(2) In (1), each of the first terminal and the second terminal may include a substrate, an electrical connector disposed on the substrate, and a photoelectric conversion element electrically connected to the electrical connector and optically connected to the optical fiber. In this case, a photoelectric conversion can be performed at each of the first terminal and the second terminal.
(3) In (2), the electrical connector of the first terminal may be electrically connected to a camera disposed at the first part. In this case, the second part can be connected to the camera through the second terminal, the optical fiber, and the first terminal.
(4) In any one of (1) to (3), a direction in which the optical fiber extends from the first terminal and a direction in which the optical fiber extends from the second terminal may each coincide with a direction in which a rotation axis of the hinge portion extends. In this case, it is possible to more reliably prevent the optical fiber from being bent when the first part is rotated via the hinge portion.
(5) In any one of (1) to (4), the second terminal may have a rectangular shape having long sides and short sides. The second terminal may be disposed in an orientation in which a direction in which the long sides extend coincides with a direction in which a rotation axis of the hinge portion extends.
(6) In any one of (1) to (4), the second terminal may have a rectangular shape having long sides and short sides. The second terminal may be disposed in an orientation in which a direction in which the long sides extend intersects a direction in which a rotation axis of the hinge portion extends.
(7) In any one of (1) to (6), the hinge portion may have a hole that the optical fiber enters. A direction in which a part of the optical fiber extending from the first terminal enters the hole may coincide with a direction in which a part of the optical fiber extending from the second terminal enters the hole. In this case, since the optical fiber extends in the same direction from the hole of the hinge portion toward the first terminal and the second terminal, the wiring structure can be made compact. Thus, the information device can be further miniaturized.
(8) In any one of (1) to (6), the hinge portion may have a hole that the optical fiber enters. A direction in which a part of the optical fiber extending from the first terminal enters the hole may differ from a direction in which a part of the optical fiber extending from the second terminal enters the hole. In this case, the optical fiber extends from the hole of the hinge portion toward the first terminal and the second terminal in different directions, and thus the bending angle of the optical fiber can be reduced. As a result, the disconnection of the optical fiber can be prevented more reliably.
(9) In any one of (1) to (8), the optical fiber may include an excess portion, the excess portion being a part in which the optical fiber is curved and being configured to maintain, when the first part is rotated with respect to the second part, a state in which the optical fiber is slack. In this case, since the optical fiber has the excess portion, the optical fiber is maintained in a slack state even when the first part is rotated via the hinge portion. Thus, the disconnection of the optical fiber can be prevented more reliably.
(10) In any one of (1) to (9), the optical fiber may include a twisted portion twisted in a state in which the first part is opened with respect to the second part. In this case, since the twist can be reduced when the first part is closed to the second part, the disconnection of the optical fiber can be prevented more reliably.

### DETAILS OF EMBODIMENTS OF PRESENT DISCLOSURE

Specific examples of an information device and a wiring structure according to embodiments of the present disclosure will be described below with reference to the drawings. The present disclosure is not limited to the following examples, but is defined by the appended claims, and is intended to include all modifications within the scope equivalent to the claims. In the description of the drawings, the same or corresponding elements are denoted by the same reference numerals, and redundant description thereof will be omitted as appropriate. In the drawings, some components may be simplified, omitted, or exaggerated for easy understanding, and the dimensional ratio and the like are not limited to those shown in the drawings.

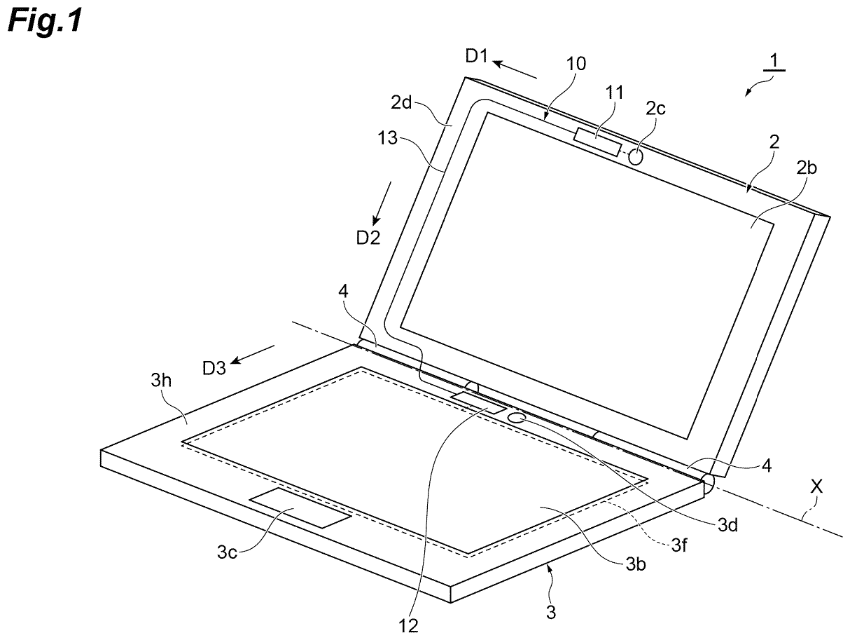

The information device includes a first part, a second part, and a hinge portion. In the following, an example in which the first part is a monitor part 2 and the second part is a body part 3 will be described. FIG. 1 is a perspective view illustrating an example of an information device 1. The information device 1 is a notebook computer. The information device 1 is a laptop. The information device 1 includes the monitor part 2, the body part 3, and a hinge portion 4. The monitor part 2 includes, for example, a display 2b, a camera 2c, and a frame portion 2d. The display 2b is, for example, a liquid crystal display, and the camera 2c is a Web camera. The display 2b and the camera 2c are driven by receiving the electric signal.

The frame portion 2d is a portion formed in a frame shape in the monitor part 2. The frame portion 2d holds, for example, the display 2b and the camera 2c. For example, the frame portion 2d is formed in a rectangular plate shape. In this case, the frame portion 2d has long sides extending along a first direction D1 and short sides extending along a second direction D2 intersecting the first direction D1. The first direction D1 is a direction in which a rotation axis X of the hinge portion 4 extends. The second direction D2 is a direction that is orthogonal to the first direction D1, extends along the frame portion 2d, and approaches the hinge portion 4.

The body part 3 includes a keyboard 3b, a touchpad 3c, a power button 3d, a motherboard 3f, and a frame portion 3h. The keyboard 3b, the touchpad 3c, and the power button 3d are electrically connected to the motherboard 3f. The keyboard 3b, the touchpad 3c, and the power button 3d are operated by a user of the information device 1. When the keyboard 3b, the touchpad 3c, and the power button 3d are operated, signals are output from the motherboard 3f to the each part of the information device 1, and the each part of the information device 1 function.

The frame portion 3h is a portion formed in a frame shape in the body part 3. The frame portion 3h holds the keyboard 3b, the touchpad 3c, and the power button 3d, and houses the motherboard 3f. For example, the frame portion 3h is formed in a rectangular plate shape. In this case, the frame portion 3h has long sides extending along the first direction D1 and short sides extending along a third direction D3 intersecting the first direction D1. The third direction D3 is a direction that is orthogonal to the first direction D1, that extends along the frame portion 3h, and that is away from the hinge portion 4.

The example of the configuration of the monitor part 2 and the body part 3 has been described above. However, the configuration of the monitor part 2 and the body part 3 is not limited to the above examples and can be changed as appropriate. The monitor part 2 and the body part 3 are connected to each other via the hinge portion 4. The hinge portion 4 is a portion that allows the monitor part 2 to rotate with respect to the body part 3 about the rotation axis X. The hinge portion 4 is, for example, tubular. As an example, the information device 1 has two hinge portions 4 disposed along the first direction D1. However, the shape and number of the hinge portion 4 are not particularly limited.

The maximum value of the rotation angle of the monitor part 2 with respect to the body part 3 is, for example, 180 degrees. In this case, when the monitor part 2 is opened to the maximum with respect to the body part 3, the display 2b is substantially parallel to the keyboard 3b. However, the maximum value of the rotation angle of the monitor part 2 with respect to the body part 3 may be 360 degrees, and is not particularly limited. When the monitor part 2 is rotated with respect to the body part 3, a first terminal 11 moves with respect to a second terminal 12, and an optical fiber 13 is pulled.

The information device 1 includes a wiring structure 10. The wiring structure 10 is built in the information device 1. In FIG. 1 and the drawings described later, at least a part of the wiring structure built in the information device is indicated by a solid line for easy understanding of the drawings. A plurality of components constituting the information device 1 are electrically connected to each other. The plurality of components constituting the information device 1 operate upon receiving an electric signal. On the other hand, the wiring structure 10 includes the optical fiber 13 and transmits an optical signal through the optical fiber 13. The wiring structure 10 includes the first terminal 11, the second terminal 12, and the optical fiber 13 configured to optically connect the first terminal 11 and the second terminal 12 to each other. For example, the wiring structure 10 includes one first terminal 11 connected to an end of the optical fiber 13 and one second terminal 12 connected to an end of the optical fiber 13 opposite to the first terminal 11. The first terminal 11 is disposed in the monitor part 2, and the second terminal 12 is disposed in the body part 3.

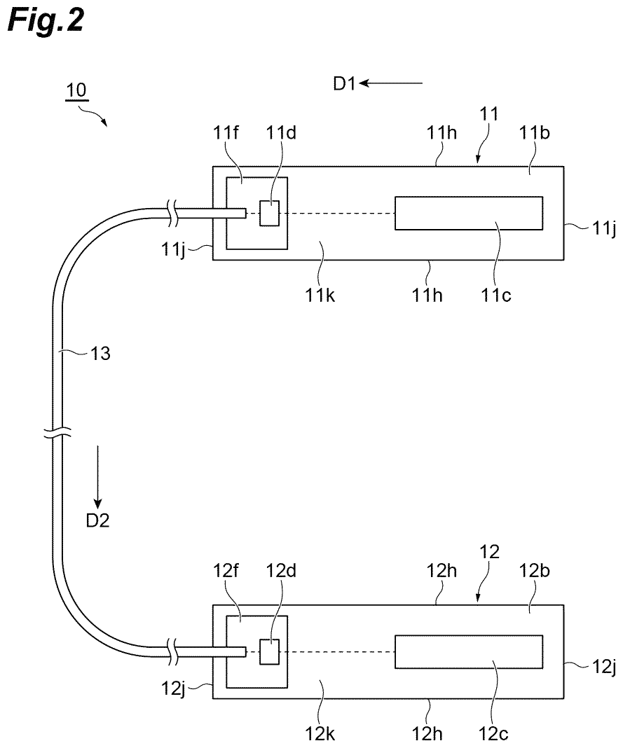

FIG. 2 is an enlarged view of the first terminal 11 and the second terminal 12 in the wiring structure 10. As shown in FIGS. 1 and 2, the first terminal 11 is formed in a rectangular shape having a long side 11h and a short side 11j. The first terminal 11 is disposed in an orientation in which a direction in which the long side 11h extends coincides with a direction (first direction D1) in which the rotation axis X of the hinge portion 4 extends.

The first terminal 11 has a pair of long sides 11h and a pair of short sides 11j. For example, the optical fiber 13 extends from the short side 11j in the first direction D1. The first terminal 11 includes a substrate 11b, an electrical connector 11c disposed on the substrate 11b, a photoelectric conversion element 11d electrically connected to the electrical connector 11c and optically connected to the optical fiber 13, and a lens unit 11f including a lens that collects light from the photoelectric conversion element 11d to the optical fiber 13.

The electrical connector 11c, the photoelectric conversion element 11d, and the lens unit 11f are mounted on the substrate 11b. The substrate 11b has a main surface 11k on which the electrical connector 11c, the photoelectric conversion element 11d, and the lens unit 11f are mounted, and a back surface facing the opposite side of the main surface 11k. The substrate 11b has, for example, a rectangular shape having the long side 11h and the short side 11j. The electrical connector 11c is electrically connected to the camera 2c. For example, the camera 2c outputs an image signal as an electrical signal to the electrical connector 11c. The type of the electrical connector 11c is not particularly limited.

The photoelectric conversion element 11d converts an electric signal into an optical signal. The photoelectric conversion element 11d is, for example, a vertical cavity surface emitting laser (VCSEL) which is a kind of semiconductor laser diode. The photoelectric conversion element 11d outputs the optical signal to, for example, a lens of the lens unit 11f, and the lens collects the optical signal to the optical fiber 13.

The optical fiber 13 includes a core and a cladding covering the core. The optical fiber 13 is covered with a coating. The optical fiber 13 is, for example, a multimode fiber. The optical fiber 13 is, for example, a glass fiber. However, the optical fiber 13 may be made of plastic, and the type and material of the optical fiber 13 are not particularly limited.

For example, the wiring structure 10 includes one or two optical fibers 13. In this case, the area occupied by the wiring structure 10 in the information device 1 can be reduced. However, the number of optical fibers 13 is not particularly limited. The optical fiber 13 extends from the first terminal 11 to the second terminal 12 through the hinge portion 4.

For example, the optical fiber 13 is disposed so as to pass through the frame portion 2d of the monitor part 2. In the embodiment, the optical fiber 13 is disposed so as to bypass the display 2b. For example, the optical fiber 13 extends from the first terminal 11 in the first direction D1, and a part of the optical fiber 13 extending in the first direction D1 is bent in the second direction D2.

For example, the optical fiber 13 extending in the second direction D2 is bent in a direction opposite to the first direction D1 at an end portion of the frame portion 2d in the second direction D2 and enters the hinge portion 4. For example, the hinge portion 4 has a hole that the optical fiber 13 enters. An example of the wiring of the optical fiber 13 in the hinge portion 4 will be described in detail later. The optical fiber 13 enters the frame portion 3h of the body part 3 from the hinge portion 4 and extends to the second terminal 12. The example of the wiring of the optical fiber 13 in the information device 1 has been described above. However, the wiring of the optical fiber 13 is not limited to the above example.

For example, the second terminal 12 has the same configuration as the first terminal 11. The second terminal 12 has a rectangular shape having a long side 12h and a short side 12j. The second terminal 12 is disposed in an orientation in which the direction in which the long side 12h extends coincides with the direction (first direction D1) in which the rotation axis X of the hinge portion 4 extends. The second terminal 12 has a pair of long sides 12h and a pair of short sides 12j.

The second terminal 12 is disposed, for example, in the same orientation as the first terminal 11. That is, the second terminal 12 is disposed in an orientation in which the direction in which the long sides 12h extend coincides with the direction in which the long sides 11h extend, and the direction in which the short sides 12j extend coincides with the direction in which the short sides 11j extend.

For example, the optical fiber 13 extends from the short side 12j in the first direction D1. In this case, the direction in which the optical fiber 13 extends from the first terminal 11 and the direction in which the optical fiber 13 extends from the second terminal 12 coincide with the direction (first direction D1) in which the rotation axis X of the hinge portion 4 extends. The expression “coincide with a direction” is not limited to a direction that is completely the same as the direction, and includes a direction that is different from the direction to the extent that the effects do not change.

For example, the second terminal 12 includes a substrate 12b, an electrical connector 12c disposed on the substrate 12b, a photoelectric conversion element 12d electrically connected to the electrical connector 12c and optically connected to the optical fiber 13, and a lens unit 12f including a lens that outputs light from the optical fiber 13 to the photoelectric conversion element 12d. The electrical connector 12c, the photoelectric conversion element 12d, and the lens unit 12f are mounted on the substrate 12b.

For example, the substrate 12b has a main surface 12k on which the electrical connector 12c, the photoelectric conversion element 12d, and the lens unit 12f are mounted, and a back surface facing the opposite side of the main surface 12k. For example, the main surface 12k of the second terminal 12 faces in the same direction as the main surface 11k of the first terminal 11.

The substrate 12b has, for example, a rectangular shape having the long sides 12h and the short sides 12j. The electrical connector 12c is electrically connected to the motherboard 3f. For example, an electrical signal is output from the electrical connector 12c to the motherboard 3f. The type of the electrical connector 12c is not particularly limited.

The photoelectric conversion element 12d converts an optical signal into an electric signal. The photoelectric conversion element 12d is, for example, a photodiode (PD). The photoelectric conversion element 12d converts, for example, an optical signal from the lens of the lens unit 12f into an electric signal. The electrical signal is output from the photoelectric conversion element 12d to the motherboard 3f via the electrical connector 12c, and is processed by the chip set mounted on the motherboard 3f.

Next, effects obtained from the information device 1 and the wiring structure 10 according to the embodiment will be described. The information device 1 and the wiring structure 10 include the first terminal 11, the second terminal 12, and the optical fiber 13. The first terminal 11 is disposed in the monitor part 2 of the information device 1, and the second terminal 12 is disposed in the body part 3 of the information device 1. The optical fiber 13 is passed through the hinge portion 4 of the information device 1 and is configured to optically connect the first terminal 11 and the second terminal 12 to each other. The first terminal 11 disposed in the monitor part 2 is connected to the second terminal 12 disposed in the body part 3 through the optical fiber 13, and thus a large amount of signal transmission can be performed by the optical fiber 13 which is thin and has a small number of fibers. Thus, since the area occupied by the optical fiber 13 in the information device 1 can be reduced, the area occupied by the wiring can be reduced, and the information device 1 can be miniaturized.

As described above, the first terminal 11 may include the substrate 11b, the electrical connector 11c disposed on the substrate 11b, and the photoelectric conversion element 11d electrically connected to the electrical connector 11c and optically connected to the optical fiber 13. In this case, the first terminal 11 can convert an electric signal into an optical signal. For example, the second terminal 12 has the same configuration as the first terminal 11. In this case, the second terminal 12 can obtain the same effect as the first terminal 11.

As described above, the electrical connector 11c of the first terminal 11 may be electrically connected to the camera 2c disposed in the monitor part 2. In this case, the body part 3 can be electrically connected to the camera 2c via the second terminal 12, the optical fiber 13, and the first terminal 11.

As described above, the direction in which the optical fiber 13 extends from the first terminal 11 and the direction in which the optical fiber 13 extends from the second terminal 12 may coincide with the direction in which the rotation axis X of the hinge portion 4 extends. In this case, the optical fiber 13 can be more reliably prevented from being bent when the monitor part 2 is rotated via the hinge portion 4. Thus, the damage and disconnection of the optical fiber 13 can be prevented more reliably.

Next, various modifications of the information device and the wiring structure according to the present disclosure will be described. The configurations of the information device and the wiring structure according to each modification described later are partially the same as the configurations of the information device 1 and the wiring structure 10 described above. Thus, in the following, the description of the same configuration as the configuration of the information device 1 and the wiring structure 10 will be appropriately omitted.

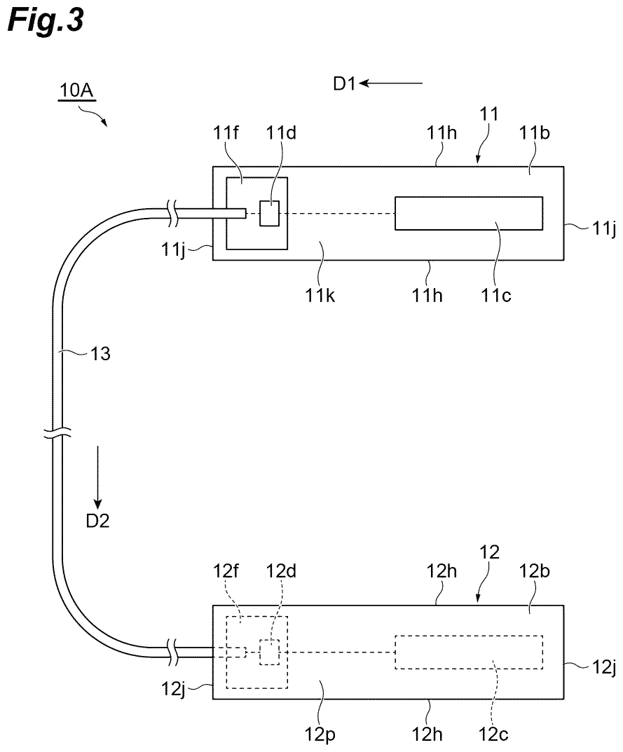

FIG. 3 is a diagram illustrating a wiring structure 10A according to a first modification. In the wiring structure 10A, the main surface 12k of the second terminal 12 faces in the opposite direction to the main surface 11k of the first terminal 11. That is, a back surface 12p of the second terminal 12 faces in the same direction as the main surface 11k of the first terminal 11. For example, the electrical connector 12c is a boat-to-board connector. In this case, the electrical connector 12c can be easily connected to the motherboard 3f.

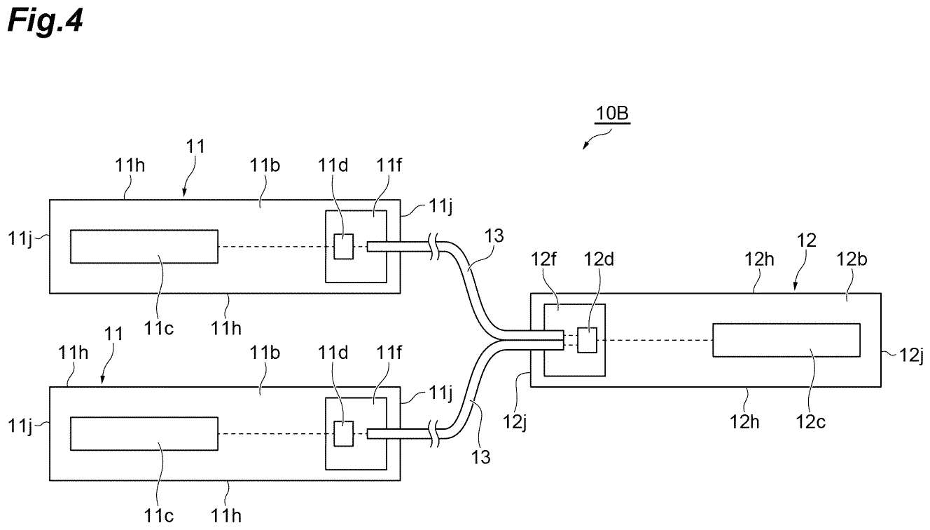

FIG. 4 is a diagram illustrating a wiring structure 10B according to a second modification. The wiring structure 10B includes two first terminals 11, the one second terminal 12, and two optical fibers 13. The two optical fibers 13 extend from the second terminal 12. The first terminal 11 is connected to each of two optical fibers 13 extending from the second terminal 12. As in the wiring structure 10B, the number of first terminals 11, the number of second terminals 12, and the number of optical fibers 13 are not particularly limited. For example, the wiring structure may include one first terminal 11, the two second terminals 12, and two optical fibers 13.

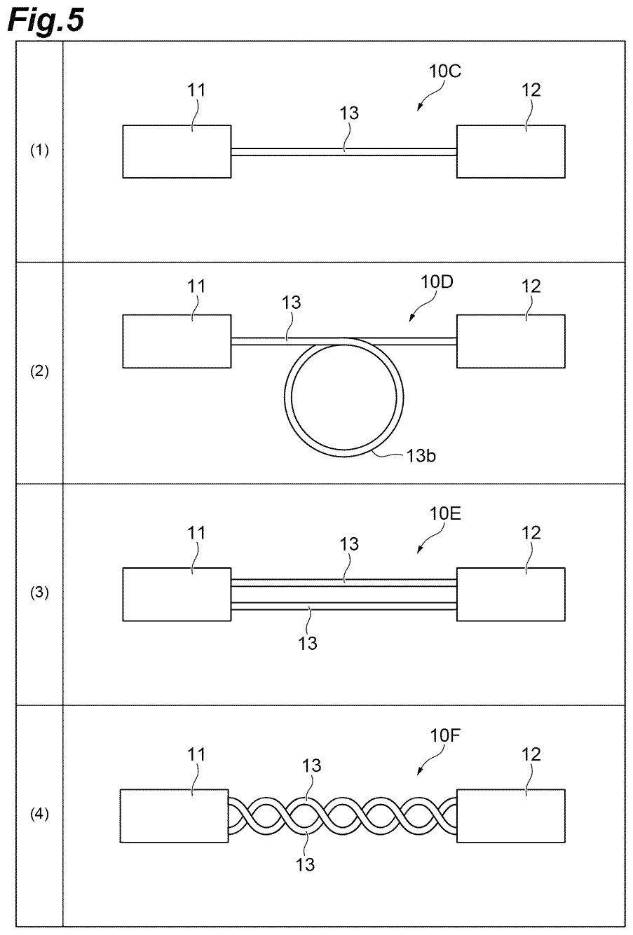

(1) in FIG. 5 is a diagram illustrating a wiring structure 10C according to a third modification. In the wiring structure 10C, the optical fiber 13 extends linearly between the first terminal 11 and the second terminal 12. (2) in FIG. 5 is a diagram illustrating a wiring structure 10D according to a fourth modification. In the wiring structure 10D, the optical fiber 13 has an annular portion 13b located between the first terminal 11 and the second terminal 12. The optical fiber 13 is bent in the annular portion 13b so as to be annular. The annular portion 13b also functions as an excess portion described later.

(3) in FIG. 5 is a diagram illustrating a wiring structure 10E according to a fifth modification. In the wiring structure 10E, the two optical fibers 13 extend linearly between the first terminal 11 and the second terminal 12. (4) in FIG. 5 is a diagram illustrating a wiring structure 10F according to a sixth modification. In the wiring structure 10F, a plurality of (for example, two) optical fibers 13 are twisted between the first terminal 11 and the second terminal 12. In this case, the plurality of optical fibers 13 can be disposed so as not to be separated from each other.

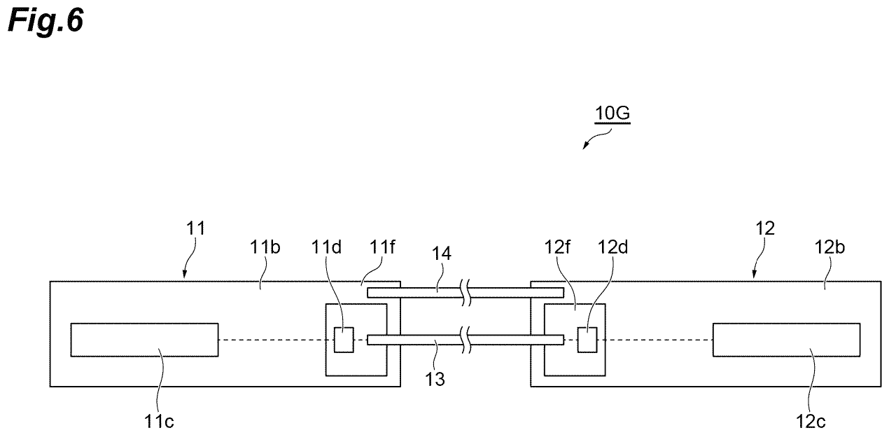

FIG. 6 is a diagram illustrating a wiring structure 10G according to a seventh modification. The wiring structure 10G further includes an electric wire 14 extending from the first terminal 11 to the second terminal 12. The electric wire 14 is fixed to each of the pad of the substrate 11b of the first terminal 11 and the pad of the substrate 12b of the second terminal 12. The electric wire 14 extends from the pad of the substrate 11b to the pad of the substrate 12b. The electric wire 14 transmits and receives an electric signal between the first terminal 11 and the second terminal 12. In this case, for example, it is possible to supply electric power to the camera 2c electrically connected to the electrical connector 11c through the electric wire 14.

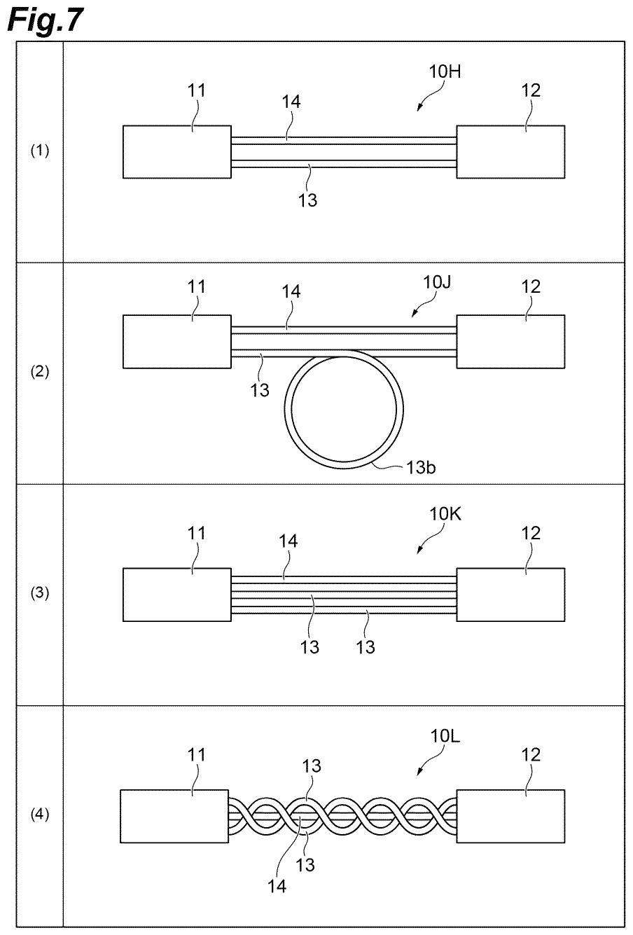

(1) in FIG. 7 is a diagram illustrating a wiring structure 10H according to an eighth modification. In the wiring structure 10H, the optical fiber 13 and the electric wire 14 extend linearly between the first terminal 11 and the second terminal 12. (2) in FIG. 7 is a diagram illustrating a wiring structure 10J according to a ninth modification. In the wiring structure 10J, the optical fiber 13 has the annular portion 13b, and the electric wire 14 extends linearly between the first terminal 11 and the second terminal 12.

(3) in FIG. 7 is a diagram illustrating a wiring structure 10K according to a tenth modification. In the wiring structure 10K, the two optical fibers 13 and one electric wire 14 extend linearly between the first terminal 11 and the second terminal 12. (4) in FIG. 7 is a diagram illustrating a wiring structure 10L according to an eleventh modification. In the wiring structure 10L, the plurality of optical fibers 13 are twisted and the electric wires 14 extend linearly between the first terminal 11 and the second terminal 12.

In each of (1) to (4) in FIG. 7, the wiring structure may include a protective tube that covers at least a part of the optical fiber 13 and the electric wire 14. The protective tube is, for example, a resin tube such as a heat-shrinkable tube. In this case, the optical fiber 13 and the electric wire 14 can be protected more reliably.

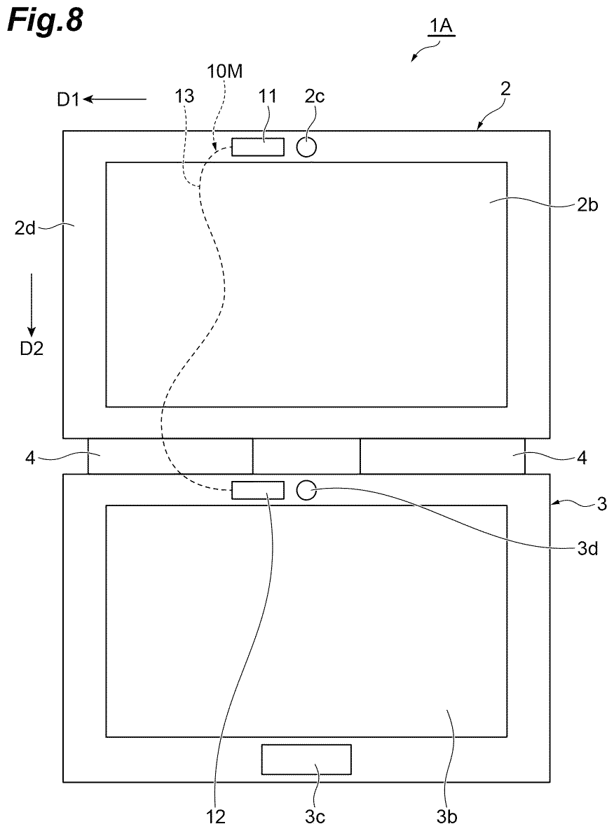

FIG. 8 is a diagram illustrating an information device 1A provided with a wiring structure 10M according to a twelfth modification. In the wiring structure 10M, the optical fiber 13 is not passed through the frame portion 2d of the monitor part 2, but is passed through the back side (the back side of the paper surface of FIG. 8) of the display 2b of the monitor part 2. That is, the optical fiber 13 extends from the first terminal 11 to the second terminal 12 via the hinge portion 4 and the region on the back side of the display 2b inside the monitor part 2. In this case, the length of the optical fiber 13 can be further shortened.

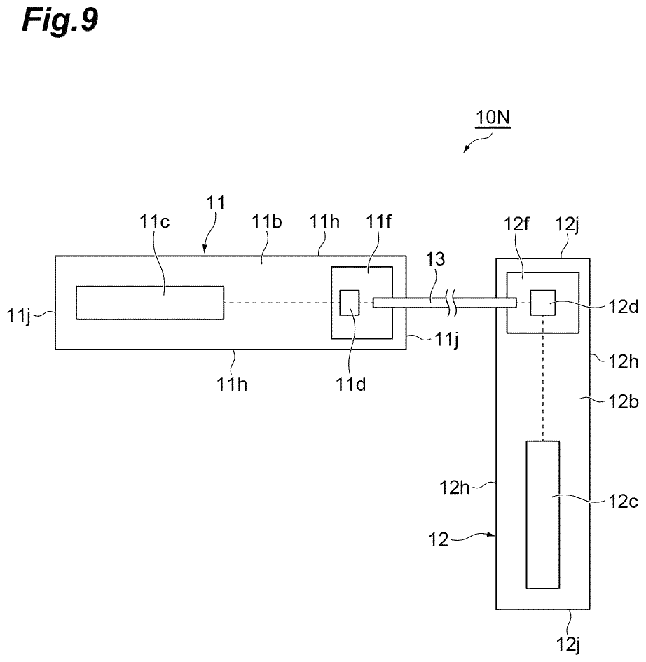

FIG. 9 is a diagram illustrating a wiring structure 10N according to a thirteenth modification. The wiring structure 10N is different from the wiring structure 10 in the orientation of the second terminal 12. In the wiring structure 10N, the second terminal 12 is disposed in an orientation different from that of the first terminal 11. The second terminal 12 is disposed in an orientation in which the direction in which the long sides 12h extend intersects (for example, is orthogonal to) the direction in which the long sides 11h extend, and the direction in which the short sides 12j extend intersects the direction in which the short sides 11j extend.

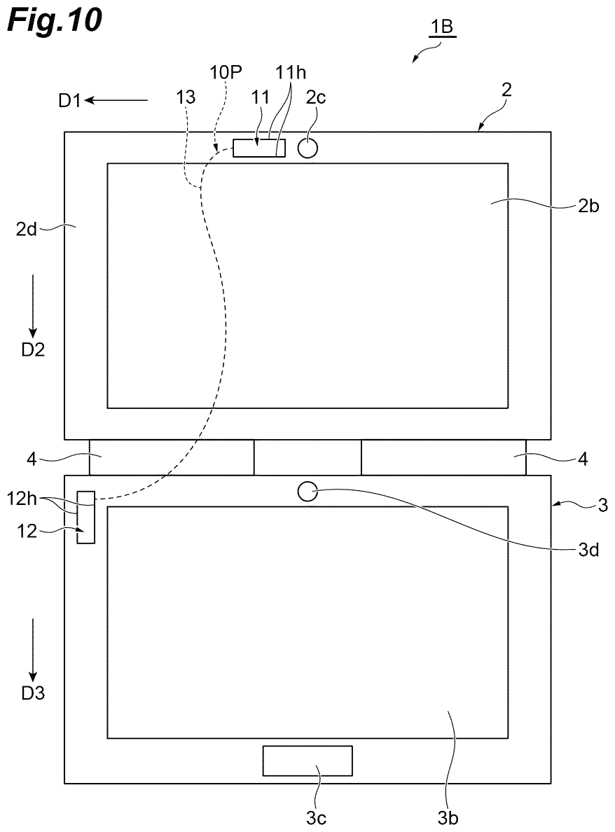

FIG. 10 is a diagram illustrating an information device 1B having a wiring structure 10P according to a fourteenth modification. The wiring structure 10P is different from the wiring structure 10 in the position where the second terminal 12 is disposed in the body part 3 and the orientation of the disposed second terminal 12. In the wiring structure 10P, the second terminal 12 is disposed in an orientation in which the direction in which the long sides 12h extend intersects the direction in which the rotation axis X of the hinge portion 4 extends.

For example, the second terminal 12 is disposed in an orientation in which the direction in which the long sides 12h extend coincides with the third direction D3. The optical fiber 13 extends from the long side 12h of the second terminal 12. As described above, the orientation and the position of the second terminal 12 in the body part 3 and the side of the second terminal 12 from which the optical fiber 13 extends can be changed as appropriate. The orientation and the position of the first terminal 11 in the monitor part 2 and the side of the first terminal 11 from which the optical fiber 13 extends can be changed as appropriate. For example, the optical fiber 13 may extend from the long side 11h of the first terminal 11.

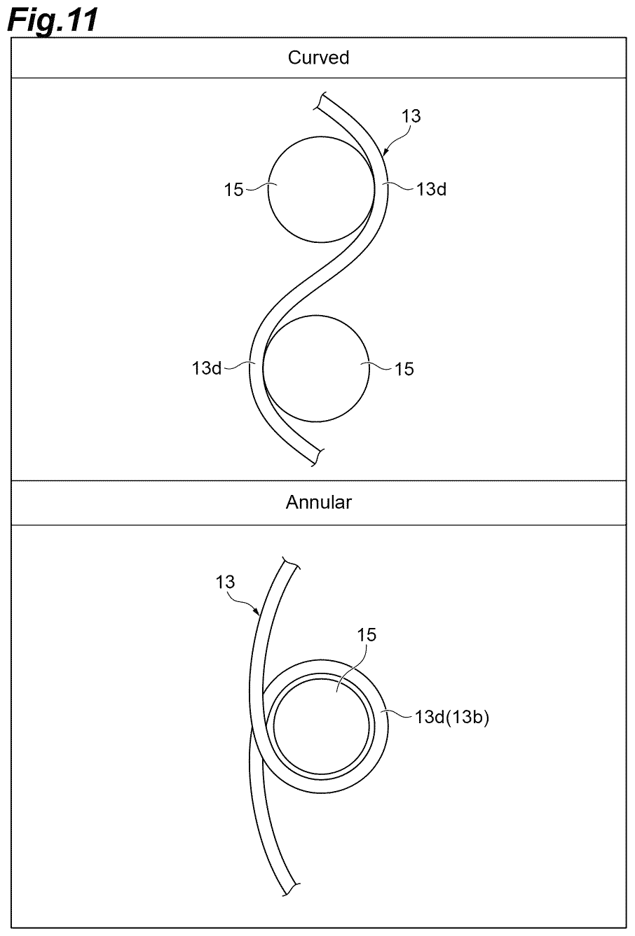

FIG. 11 is a diagram illustrating a wiring structure related to a fifteenth modification and a sixteenth modification. The wiring structure according to the fifteenth modification has an excess portion 13d in which the optical fiber 13 is curved as shown in “Curved” of FIG. 11. As described above, when the monitor part 2 rotates with respect to the body part 3, the first terminal 11 moves with respect to the second terminal 12, and the optical fiber 13 is pulled. When a strong tensile force acts on the optical fiber 13, the optical fiber 13 may be broken.

When the optical fiber 13 has the excess portion 13d, the tensile force applied to the optical fiber 13 during the rotation of the monitor part 2 can be reduced, and the disconnection of the optical fiber 13 can be more reliably prevented. The “excess portion” indicates a portion in which the optical fiber is maintained in a slack state even when the monitor part is rotated with respect to the body part and the optical fiber is pulled. The “excess portion” is, for example, a portion that is curved in advance so that no tension is applied to the optical fiber even when the monitor part is rotated to the maximum (for example, 180 degrees or 360 degrees) with respect to the body part.

The wiring structure according to the fifteenth modification includes a guide 15 built in the information device 1. For example, a plurality of guides 15 are provided inside the information device 1, and the optical fiber 13 is passed between the plurality of guides 15, and thus the excess portion 13d is formed in an S-shape. As an example, the guide 15 is formed in a cylindrical shape. The wiring structure according to the sixteenth modification has the guide 15 as shown in the “Annular” of FIG. 11, and the excess portion 13d as the annular portion 13b is formed by the optical fiber 13 circulating around the guide 15.

As described above, the shape of the excess portion 13d may be an S-shape, an annular shape, or a U-shape, and the shape of the excess portion 13d can be appropriately changed. The width of the excess portion 13d is, for example, 5 cm to 10 cm. However, the length of the excess portion 13d can be changed as appropriate.

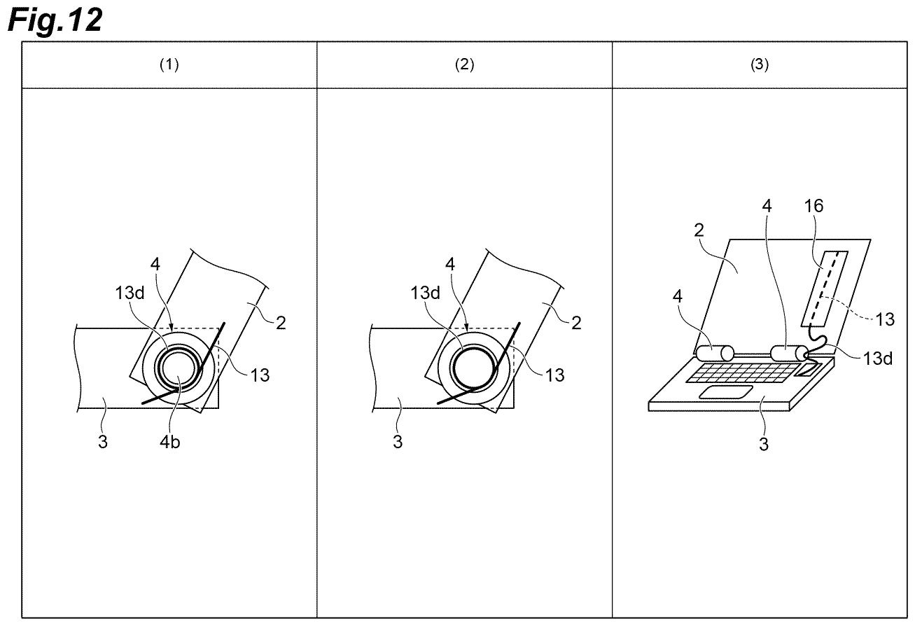

FIG. 12 is a diagram illustrating the wiring structure relating to a seventeenth modification, an eighteenth modification, and a nineteenth modification. As shown in (1) in FIG. 12, in the seventeenth modification, the hinge portion 4 has a shaft 4b. The optical fiber 13 has the excess portion 13d surrounding the shaft 4b. As shown in (2) in FIG. 12, in the eighteenth modification, the hinge portion 4 doesn't have to have the shaft 4b. The optical fiber 13 has the excess portion 13d extending annularly along the inner periphery of the cylindrical hinge portion 4.

As shown in (3) in FIG. 12, in the nineteenth modification, the excess portion 13d may be formed at a position other than the hinge portion 4. For example, the optical fiber 13 may have the excess portion 13d positioned between a fixation member 16 for fixing the optical fiber 13 and the hinge portion 4. The fixation member 16 is, for example, a tape for fixing the optical fiber 13. However, the fixation member 16 may be an adhesive, and the type of the fixation member 16 is not particularly limited. For example, the fixation member 16 may have a concave-convex structure in which the optical fiber 13 is fitted.

As described above, the optical fiber 13 may include an excess portion 13d, the excess portion 13d being a part in which the optical fiber 13 is curved and being configured to maintain, when the monitor part 2 rotates with respect to the body part 3, a state in which the optical fiber 13 is slack. In this case, since the optical fiber 13 include the excess portion 13d, the optical fiber 13 is maintained in a slack state even when the monitor part 2 is rotated via the hinge portion 4. Thus, the disconnection of the optical fiber 13 can be prevented more reliably.

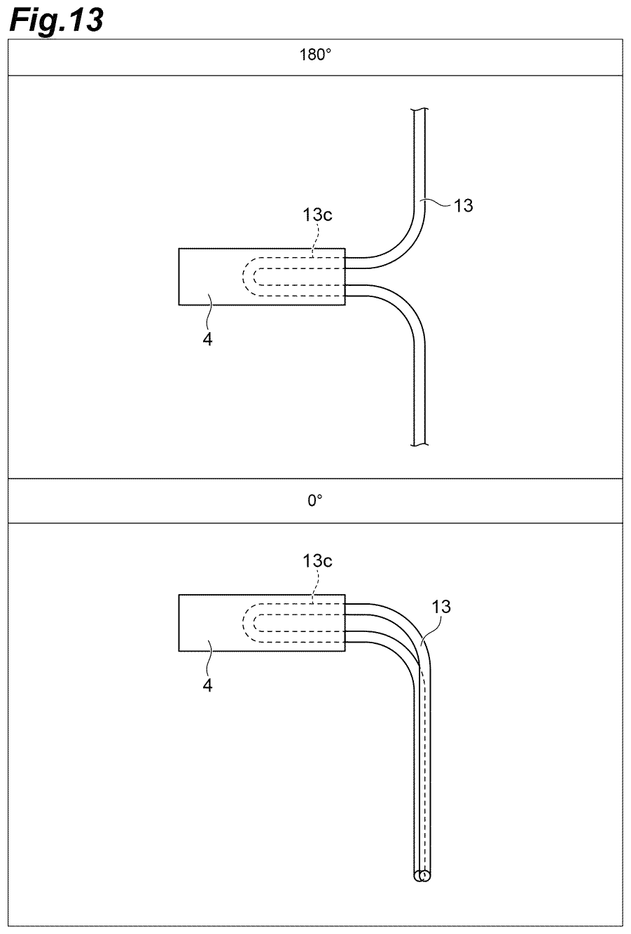

FIG. 13 is a diagram illustrating a wiring structure according to a twentieth modification. FIG. 13 shows the optical fiber 13 and the hinge portion 4 when the rotation angle of the monitor part 2 with respect to the body part 3 is 180 degrees, and the optical fiber 13 and the hinge portion 4 when the rotation angle of the monitor part 2 with respect to the body part 3 is 0 degrees. The optical fiber 13 has a twisted portion 13c twisted with respect to the body part 3 in a state where the monitor part 2 is opened.

For example, the twisted portion 13c is inserted into the hinge portion 4. As an example, the twisted portion 13c is twisted when the monitor part 2 is opened at the maximum angle (for example, 180 degrees) with respect to the body part 3, and the twist of the twisted portion 13c is reduced as the rotation angle of the monitor part 2 with respect to the body part 3 is reduced. For example, when the monitor part 2 is not opened with respect to the body part 3 (when the rotation angle is 0 degrees), the twisted portion 13c is not twisted.

As described above, the optical fiber 13 may include the twisted portion 13c twisted with respect to the body part 3 in the state where the monitor part 2 is opened. In this case, since the twist of the optical fiber 13 can be reduced when the monitor part 2 is closed to the body part 3, the disconnection of the optical fiber 13 can be prevented more reliably. The twisted portion 13c may be formed by reversing the orientation of the main surface 11k of the substrate 11b and the orientation of the main surface 12k of the substrate 12b.

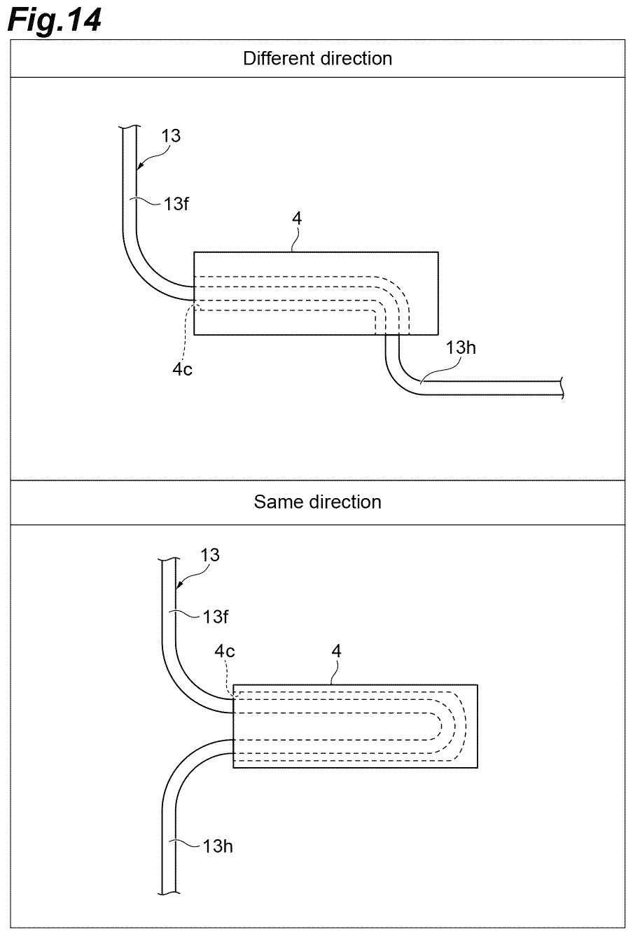

FIG. 14 is a diagram illustrating a wiring structure related to a twenty-first modification and a twenty-second modification. The hinge portion 4 has a hole 4c into which the optical fiber 13 is inserted. The number of the holes 4c may be one, or two or more. A part 13f extending from the first terminal 11 of the optical fiber 13 and a part 13h extending from the second terminal 12 of the optical fiber 13 enter the hole 4c. As in “Different direction” of FIG. 14 which is the twenty-first modification, the direction in which the part 13f enters the hole 4c may be different from the direction in which the part 13h enters the hole 4c. As in “Same direction” of FIG. 14 which is the twenty-second modification, the direction in which the part 13f enters the hole 4c may coincide with the direction in which the part 13h enters the hole 4c.

As described above, in the twenty-first modification, the direction in which the part 13f extending from the first terminal 11 of the optical fiber 13 enters the hole 4c of the hinge portion 4 is different from the direction in which the part 13h extending from the second terminal 12 of the optical fiber 13 enters the hole 4c. In this case, the optical fiber 13 extends from the hole 4c of the hinge portion 4 toward the first terminal 11 and the second terminal 12 in different directions, and thus the bending angle of the optical fiber 13 can be reduced. For example, the bending angle of the optical fiber 13 can be relaxed to 90 degrees or more. As a result, the disconnection of the optical fiber 13 can be prevented more reliably.

In the twenty-second modification, the direction in which the part 13f extending from the first terminal 11 of the optical fiber 13 enters the hole 4c of the hinge portion 4 coincides with the direction in which the part 13h extending from the second terminal 12 of the optical fiber 13 enters the hole 4c. In this case, the optical fiber 13 extends from the hole 4c of the hinge portion 4 toward the first terminal 11 and the second terminal 12 in the same direction, and thus the wiring structure can be made compact. Thus, the information device 1 can be further miniaturized.

When the monitor part 2 is opened and closed, the optical fiber 13 may be rubbed in the hinge portion 4. In this case, the wiring structure may include a protection tube that covers a part of the optical fiber 13 inserted into the hinge portion 4. The protective tube is, for example, a resin tube such as a heat-shrinkable tube. In this case, since the part of the optical fiber 13 inserted into the hinge portion 4 is protected by the protective tube, the possibility of the optical fiber 13 being rubbed is reduced, and the optical fiber 13 can be protected more reliably.

Embodiments and various modifications of the information device and the wiring structure according to the present disclosure have been described above. However, the present disclosure is not limited to the embodiments or various modifications described above. That is, it is easily recognized by those skilled in the art that various modifications and changes can be made within the scope of the gist described in the claims. That is, the shape, size, number, material, and arrangement of each part of the information device and the wiring structure can be appropriately changed within the scope of the above gist. Although the embodiment and the first modification to the twenty-second modification have been described above, the information device and the wiring structure according to the present disclosure may be a combination of a part of a form selected from at least one of the embodiment and the first modification to the twenty-second modification and a remaining part different from the form. As described above, the above-described embodiment and the first modification to the twenty-second modification can be appropriately combined.

For example, in the above-described embodiment, the first terminal 11 having the electrical connector 11c electrically connected to the camera 2c has been described. However, the camera may be mounted on the substrate 11b of the first terminal 11. The first terminal 11 may be electrically connected to a device different from the camera 2c, for example, the display 2b of the monitor part 2. As described above, the configuration of the first terminal 11 and the type of the components of the information device 1 to which the first terminal 11 is connected are not particularly limited. The same applies to the configuration of the second terminal 12 and the types of components of the information device 1 to which the second terminal 12 is connected.

In the above-described embodiment, the information device 1 in which the first part is the monitor part 2 and the second part is the body part 3 has been described. However, the first part may not be the monitor part 2, and the second part may not be the body part 3. As described above, the function of the first part and the function of the second part are not particularly limited.

In the above-described embodiment, the information device 1 which is a notebook computer has been described. However, the information device having the wiring structure according to the present disclosure may be a device other than the notebook computer. That is, the information device may be any device capable of transmitting information, and the type of the information device is not particularly limited.

What is claimed is:

1. An information device including a first part and a second part connected to each other via a hinge portion, the information device comprising:
a first terminal disposed at the first part;
a second terminal disposed at the second part; and
an optical fiber configured to optically connect the first terminal and the second terminal to each other,
wherein the optical fiber extends from the first terminal to the second terminal through the hinge portion.

2. The information device according to claim 1,
wherein each of the first terminal and the second terminal includes
a substrate,
an electrical connector disposed on the substrate, and
a photoelectric conversion element electrically connected to the electrical connector and optically connected to the optical fiber.

3. The information device according to claim 2,
wherein the electrical connector of the first terminal is electrically connected to a camera disposed at the first part.

4. The information device according to claim 1,
wherein a direction in which the optical fiber extends from the first terminal and a direction in which the optical fiber extends from the second terminal each coincide with a direction in which a rotation axis of the hinge portion extends.

5. The information device according to claim 1,
wherein the second terminal has a rectangular shape with long sides and short sides, and
wherein the second terminal is disposed in an orientation in which a direction in which the long sides extend coincides with a direction in which a rotation axis of the hinge portion extends.

6. The information device according to claim 1,
wherein the second terminal has a rectangular shape with long sides and short sides, and
wherein the second terminal is disposed in an orientation in which a direction in which the long sides extend intersects a direction in which a rotation axis of the hinge portion extends.

7. The information device according to claim 1,
wherein the hinge portion has a hole that the optical fiber enters, and
wherein a direction in which a part of the optical fiber extending from the first terminal enters the hole coincides with a direction in which a part of the optical fiber extending from the second terminal enters the hole.

8. The information device according to claim 1,
wherein the hinge portion has a hole that the optical fiber enters, and
wherein a direction in which a part of the optical fiber extending from the first terminal enters the hole differs from a direction in which a part of the optical fiber extending from the second terminal enters the hole.

9. The information device according to claim 1,
wherein the optical fiber includes an excess portion, the excess portion being a part in which the optical fiber is curved and being configured to maintain, when the first part is rotated with respect to the second part, a state in which the optical fiber is slack.

10. The information device according to claim 1,
wherein the optical fiber includes a twisted portion twisted in a state in which the first part is opened with respect to the second part.

11. A wiring structure configured to be provided in an information device including a first part and a second part connected to each other via a hinge portion, the wiring structure comprising:
a first terminal disposed at the first part;
a second terminal disposed at the second part; and
an optical fiber configured to optically connect the first terminal and the second terminal to each other,
wherein the optical fiber is disposed to extend from the first terminal to the second terminal through the hinge portion.
